(19) United States
(12) Patent Application Publication
(10) Pub. No.: US 2025/0350958 A1
(43) Pub. Date: Nov. 13, 2025

(54) TECHNIQUES FOR CROSS-TECHNOLOGY SIGNALING

(71) Applicant: QUALCOMM Incorporated, San Diego, CA (US)

(72) Inventors: Aleksandar DAMNJANOVIC, Del Mar, CA (US); Bin TIAN, San Diego, CA (US); Vikas JAIN, San Diego, CA (US); Siva Kumar JUJARAY, San Diego, CA (US)

(21) Appl. No.: 19/073,261

(22) Filed: Mar. 7, 2025

Related U.S. Application Data
(60) Provisional application No. 63/644,228, filed on May 8, 2024.

(51) Int. Cl. H04W 16/14; H04W 84/12

(52) U.S. Cl. CPC H04W 16/14; H04W 84/12

(57) ABSTRACT

Various aspects of the present disclosure generally relate to wireless communication. In some aspects, a wireless communication device may identify a waveform, the waveform generated based at least in part on a first radio access technology (RAT) and a second RAT. The wireless communication device may transmit a signal of the second RAT based at least in part on the waveform. Numerous other aspects are described.

### CROSS-REFERENCE TO RELATED APPLICATION

This Patent Application claims priority to U.S. Provisional Patent Application No. 63/644,228, filed on May 8, 2024, entitled “TECHNIQUES FOR CROSS-TECHNOLOGY SIGNALING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods for cross-technology signaling.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

A wireless local area network (WLAN) may be formed by one or more access points (APs) that provide a shared wireless communication medium for use by a number of client devices, also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

To improve data throughput, the AP may communicate with one or more STAs over multiple concurrent communication links. Each of the communication links may be of various bandwidths, for example, by bonding a number of 20 MHz-wide channels together to form 40 MHz-wide channels, 80 MHz-wide channels, or 160 MHz-wide channels. The AP may establish BSSs on any of the different communication links, and therefore it is desirable to improve communication between the AP and the one or more STAs over each of the communication links.

### SUMMARY

Some aspects described herein relate to an apparatus for wireless communication at a wireless communication device. The apparatus may include one or more memories and one or more processors coupled to the one or more memories. The one or more processors may be configured to identify a waveform, the waveform generated based at least in part on a first radio access technology (RAT) and a second RAT. The one or more processors may be configured to transmit a signal of the second RAT based at least in part on the waveform.

Some aspects described herein relate to an apparatus for wireless communication at an access point. The apparatus may include one or more memories and one or more processors coupled to the one or more memories. The one or more processors may be configured to receive a signal of a second RAT that is based at least in part on a waveform, the waveform generated based at least in part on a first RAT and the second RAT. The one or more processors may be configured to demodulate the signal of the second RAT in accordance with a protocol for the second RAT.

Some aspects described herein relate to a method of wireless communication performed by a wireless communication device. The method may include identifying a waveform, the waveform generated based at least in part on a first RAT and a second RAT. The method may include transmitting a signal of the second RAT based at least in part on the waveform.

Some aspects described herein relate to a method of wireless communication performed by an access point. The method may include receiving a signal of a second RAT that is based at least in part on a waveform, the waveform generated based at least in part on a first RAT and the second RAT. The method may include demodulating the signal of the second RAT in accordance with a protocol for the second RAT.

Some aspects described herein relate to a non-transitory computer-readable medium that stores a set of instructions for wireless communication by a wireless communication device. The set of instructions, when executed by one or more processors of the wireless communication device, may cause the wireless communication device to identify a waveform, the waveform generated based at least in part on a first RAT and a second RAT. The set of instructions, when executed by one or more processors of the wireless communication device, may cause the wireless communication device to transmit a signal of the second RAT based at least in part on the waveform.

Some aspects described herein relate to a non-transitory computer-readable medium that stores a set of instructions for wireless communication by an access point. The set of instructions, when executed by one or more processors of the access point, may cause the access point to receive a signal of a second RAT that is based at least in part on a waveform, the waveform generated based at least in part on a first RAT and the second RAT. The set of instructions, when executed by one or more processors of the access point, may cause the access point to demodulate the signal of the second RAT in accordance with a protocol for the second RAT.

Some aspects described herein relate to an apparatus for wireless communication. The apparatus may include means for identifying a waveform, the waveform generated based at least in part on a first RAT and a second RAT. The apparatus may include means for transmitting a signal of the second RAT based at least in part on the waveform.

Some aspects described herein relate to an apparatus for wireless communication. The apparatus may include means for receiving a signal of a second RAT that is based at least in part on a waveform, the waveform generated based at least in part on a first RAT and the second RAT. The apparatus may include means for demodulating the signal of the second RAT in accordance with a protocol for the second RAT.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network.

FIG. 3 is a diagram illustrating an example disaggregated base station architecture in accordance with the present disclosure.

FIG. 4 shows a diagram illustrating an example wireless communication network.

FIG. 5 is a diagram illustrating an example of cross-technology sharing, in accordance with the present disclosure.

FIG. 6 is a diagram illustrating an example of cross-technology signaling, in accordance with the present disclosure.

FIG. 7A is a diagram illustrating an example of cross-technology signaling, in accordance with the present disclosure.

FIG. 7B is a diagram illustrating an example of cross-technology signaling, in accordance with the present disclosure.

FIG. 8 is a diagram illustrating an example process performed, for example, at a wireless communication device or an apparatus of a wireless communication device, in accordance with the present disclosure.

FIG. 9 is a diagram illustrating an example process performed, for example, at an access point or an apparatus of an access point, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may communicate with a network node using a licensed spectrum. The licensed spectrum may be used, for example, for international mobile telecommunications (IMT) communications between the UE and the network node. Additionally, the UE may communicate with an access point using an unlicensed spectrum. The unlicensed spectrum may be used, for example, for Wi-Fi communications between the UE and the access point. In some examples, the licensed spectrum may be associated with outdoor communications between the UE and the network node, while the unlicensed spectrum may be associated with indoor communications between the UE and the access point. In some cases, a portion of the licensed spectrum (for example, an upper portion of a 6 gigahertz (GHz) spectrum) may overlap with a portion of the unlicensed spectrum. Moreover, a mobile service and Wi-Fi may use spectrum in the same geographical area, which may result in interference to communications between the UE, the network node, and/or the access point.

In a hybrid sharing framework, different technologies, such as high power macro cellular (e.g., 5G/6G) and Wi-Fi (e.g., IEEE 802.11bc), may share a spectrum. Furthermore, a UE and/or a network node may transmit cross-technology signaling to an access point in connection with hybrid sharing. For example, the cross-technology signaling may indicate spectrum sharing information and/or may be used for interference detection or characterization. In some examples, the cross-technology signaling may utilize a Wi-Fi waveform, which may be more suitable for transmission. However, while most UEs are equipped with a Wi-Fi modem that can generate a Wi-Fi waveform used in cross-technology signaling, a network node and some UEs may not be equipped with a Wi-Fi modem. Moreover, adding a Wi-Fi modem to a network node may complicate operations of the network node. Accordingly, such devices may be unable to transmit cross-technology signaling, which may lead to increases in cross-technology collisions and inefficient utilization of the spectrum by multiple technologies.

Various aspects relate generally to cross-technology signaling between a first radio access technology (RAT) and a second RAT. Some aspects more specifically relate to transmitting a signal of the second RAT using a waveform that is generated based at least in part on the first RAT and the second RAT. For example, the waveform may be generated based at least in part on signal characteristics used by the first RAT or the second RAT (e.g., baseband sampling rate or carrier frequency). In some aspects, the waveform may duplicate information over multiple frequency ranges corresponding to channels of the second RAT that overlap with a transmission bandwidth of the first RAT.

Particular aspects of the subject matter described in this disclosure can be implemented to realize one or more of the following potential advantages. In some examples, by using cross-technology signaling, the described techniques can be used to facilitate interference management in spectrum sharing scenarios, thereby minimizing cross-technology collisions and improving utilization of the spectrum by multiple technologies. In some examples, by using a waveform that is generated based at least in part on the first RAT and the second RAT, the described techniques compensate for mismatched signal characteristics between the first RAT and the second RAT to enable the signal of the second RAT to be transmitted using equipment (e.g., a modem or a transceiver) for the first RAT. In some examples, by duplicating information of the waveform over multiple frequency ranges corresponding to channels of the second RAT, the described techniques resolve differences between a transmission bandwidth of the first RAT and channel bandwidths of the second RAT, thereby improving a performance of the cross-technology signaling (e.g., in scenarios in which a primary channel of the second RAT is unknown to a transmitting device).

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

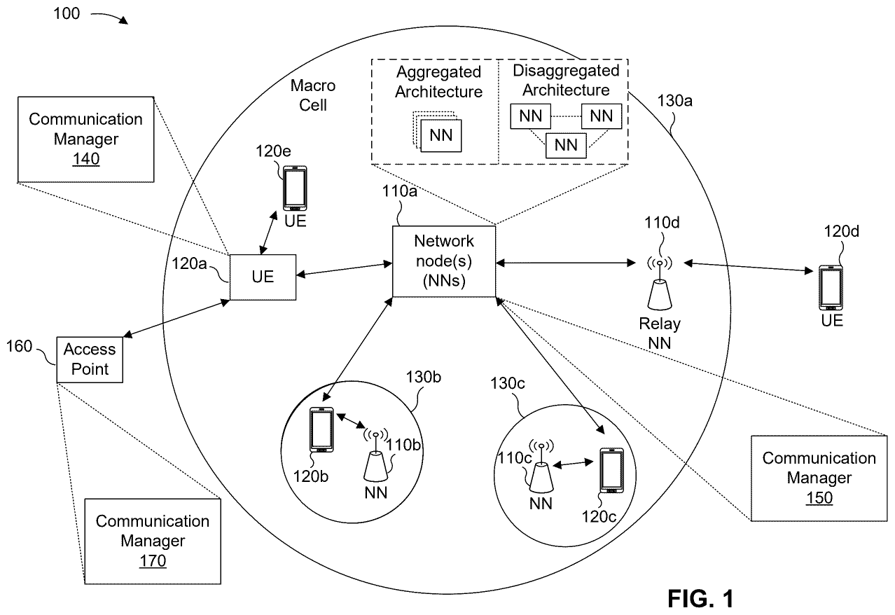

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and cach UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120aand UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

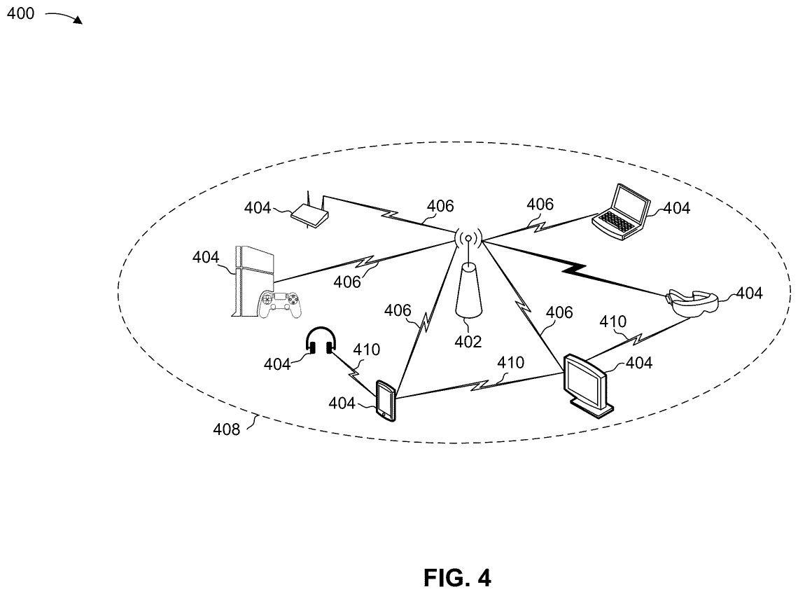

In some examples, the wireless communication network 100 may include an access point 160, as described further in connection with FIG. 4.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the network node 110 may include a communication manager 150. As described in more detail elsewhere herein, the communication manager 150 may identify a waveform, the waveform generated based at least in part on a first RAT and a second RAT; and transmit a signal of the second RAT based at least in part on the waveform. Additionally, or alternatively, the communication manager 150 may perform one or more other operations described herein.

In some aspects, the UE 120 may include a communication manager 140. As described in more detail elsewhere herein, the communication manager 140 may identify a waveform, the waveform generated based at least in part on a first RAT and a second RAT; and transmit a signal of the second RAT based at least in part on the waveform. Additionally, or alternatively, the communication manager 140 may perform one or more other operations described herein.

In some aspects, the access point 160 may include a communication manager 170. As described in more detail elsewhere herein, the communication manager 170 may receive a signal of a second RAT that is based at least in part on a waveform, the waveform generated based at least in part on a first RAT and the second RAT; and demodulate the signal of the second RAT in accordance with a protocol for the second RAT. Additionally, or alternatively, the communication manager 170 may perform one or more other operations described herein.

As indicated above, FIG. 1 is provided as an example. Other examples may differ from what is described with regard to FIG. 1.

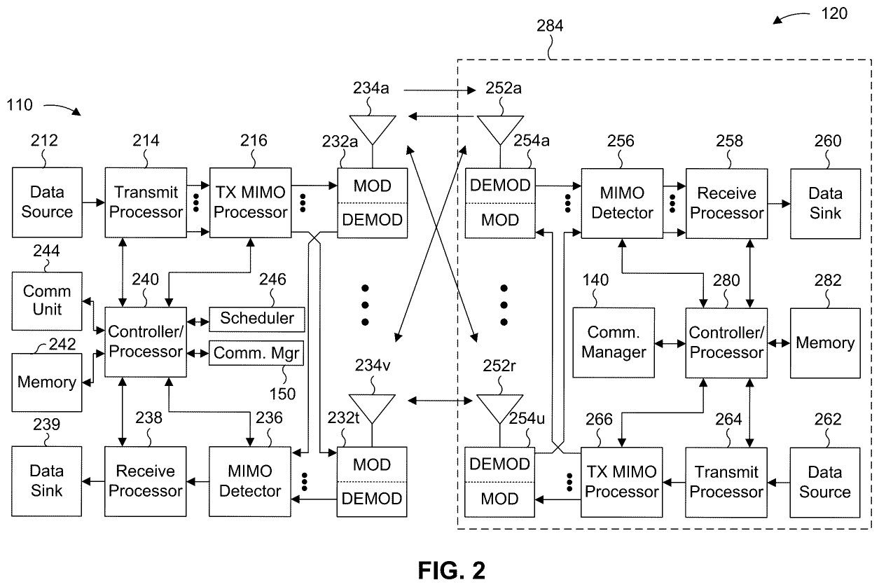

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, cach output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

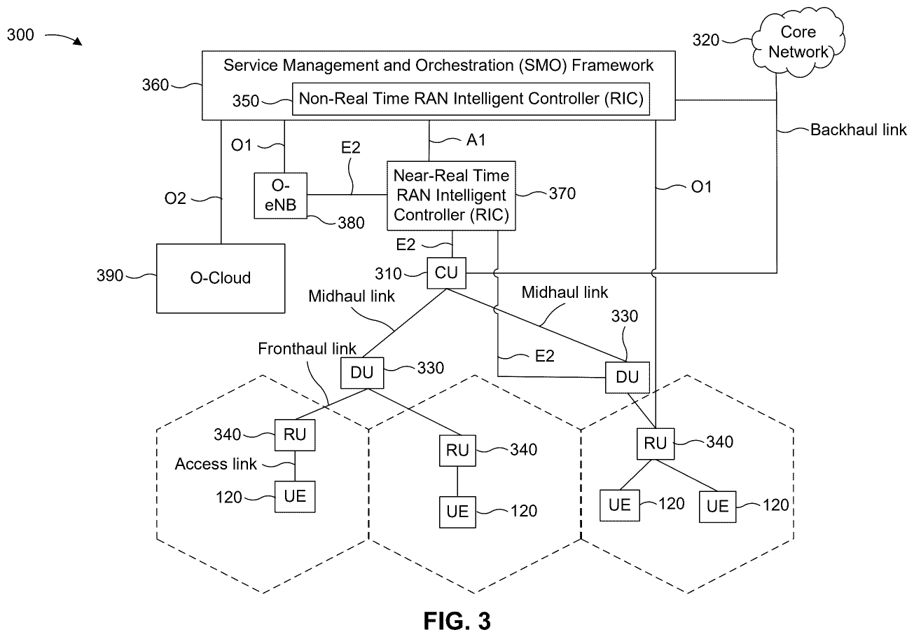

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-cNB) 380, via an O1 interface. Additionally or alternatively, the SMO Framework 360 may communicate directly with each of one or more RUs 340 via a respective O1 interface. In some deployments, this configuration can enable cach DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

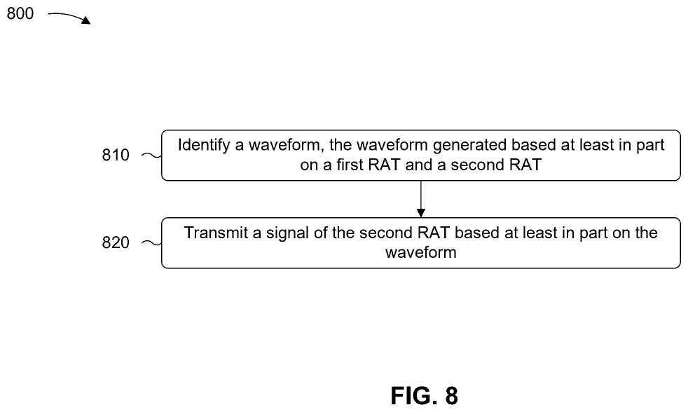

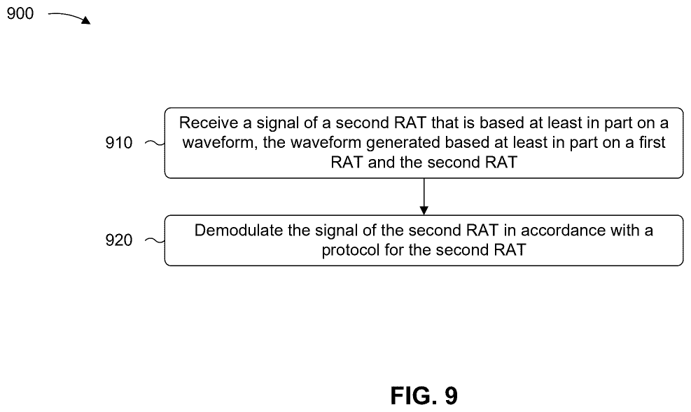

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with cross-technology signaling, as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). In some aspects, the wireless communication device described herein is the network node 110, is included in the network node 110, or includes one or more components of the network node 110 shown in FIG. 2. In some aspects, the wireless communication device described herein is the UE 120, is included in the UE 120, or includes one or more components of the UE 120 shown in FIG. 2. In some aspects, the access point described herein is the network node 110, is included in the network node 110, or includes one or more components of the network node 110 shown in FIG. 2. The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, a wireless communication device (e.g., a network node 110 or a UE 120) includes means for identifying a waveform, the waveform generated based at least in part on a first RAT and a second RAT; and/or means for transmitting a signal of the second RAT based at least in part on the waveform. In some aspects, the means for the wireless communication device to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246. In some aspects, the means for the wireless communication device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the access point 160 includes means for receiving a signal of a second RAT that is based at least in part on a waveform, the waveform generated based at least in part on a first RAT and the second RAT; and/or means for demodulating the signal of the second RAT in accordance with a protocol for the second RAT. In some aspects, the means for the access point 160 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

FIG. 4 is a diagram illustrating an example wireless communication network 400. According to some aspects, the wireless communication network 400 can be an example of a WLAN such as a Wi-Fi network. For example, the wireless communication network 400 can be a network implementing at least one of the IEEE 802.11 family of wireless communication (e.g., WLAN) protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 400 can be an example of a cellular radio access network (RAN), such as a 5G or 6G RAN that implements one or more cellular protocols such as those specified in one or more 3GPP standards. In some other examples, the wireless communication network 400 can include a WLAN that functions in an interoperable or converged manner with one or more cellular RANs to provide greater or enhanced network coverage to wireless communication devices within the wireless communication network 400 or to enable such devices to connect to a cellular network's core, such as to access the network management capabilities and functionality offered by the cellular network core. In some other examples, the wireless communication network 400 can include a WLAN that functions in an interoperable or converged manner with one or more personal area networks, such as a network implementing Bluetooth® technologies or other wireless technologies, to provide greater or enhanced network coverage or to provide or enable other capabilities, functionality, applications or services.

The wireless communication network 400 may include numerous wireless communication devices including a wireless access point (AP) 402 (e.g., corresponding to access point 160) and any number of wireless stations (STAs) 404. While only one AP 402 is shown in FIG. 4, the wireless communication network 400 can include multiple APs 402 (for example, in an extended service set (ESS) deployment, enterprise network or AP mesh network), or may not include any AP at all (for example, in an independent basic service set (IBSS) such as a peer-to-peer (P2P) network or other ad hoc network). The AP 402 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 404 also may be referred to as a mobile station (MS), a mobile device, a mobile handset, a wireless handset, an access terminal (AT), a UE, a subscriber station (SS), or a subscriber unit, among other examples. The STAs 404 may represent various devices such as mobile phones, other handheld or wearable communication devices, netbooks, notebook computers, tablet computers, laptops, Chromebooks, augmented reality (AR), virtual reality (VR), mixed reality (MR) or XR wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 402 and an associated set of STAs 404 may be referred to as an infrastructure basic service set (BSS), which is managed by the respective AP 402. FIG. 4 additionally shows an example coverage area 408 of the AP 402, which may represent a basic service area (BSA) of the wireless communication network 400. The BSS may be identified by STAs 404 and other devices by a service set identifier (SSID), as well as a basic service set identifier (BSSID), which may be a medium access control (MAC) address of the AP 402. The AP 402 may periodically broadcast beacon frames (“beacons”) including the BSSID to enable any STAs 404 within wireless range of the AP 402 to “associate” or re-associate with the AP 402 to establish a respective communication link 406 (hereinafter also referred to as a “Wi-Fi link”), or to maintain a communication link 406, with the AP 402. For example, the beacons can include an identification or indication of a primary channel used by the respective AP 402 as well as a timing synchronization function (TSF) for establishing or maintaining timing synchronization with the AP 402. The AP 402 may provide access to external networks to various STAs 404 in the wireless communication network 400 via respective communication links 406.

To establish a communication link 406 with an AP 402, each of the STAs 404 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 404 listens for beacons, which are transmitted by respective APs 402 at periodic time intervals referred to as target beacon transmission times (TBTTs). To perform active scanning, a STA 404 generates and sequentially transmits probe requests on each channel to be scanned and listens for probe responses from APs 402. Each STA 404 may identify, determine, ascertain, or select an AP 402 with which to associate in accordance with the scanning information obtained through the passive or active scans, and to perform authentication and association operations to establish a communication link 406 with the selected AP 402. The selected AP 402 assigns an association identifier (AID) to the STA 404 at the culmination of the association operations, which the AP 402 uses to track the STA 404.

As a result of the increasing ubiquity of wireless networks, a STA 404 may have the opportunity to select one of many BSSs within range of the STA 404 or to select among multiple APs 402 that together form an extended service set (ESS) including multiple connected BSSs. For example, the wireless communication network 400 may be connected to a wired or wireless distribution system that may enable multiple APs 402 to be connected in such an ESS. As such, a STA 404 can be covered by more than one AP 402 and can associate with different APs 402 at different times for different transmissions. Additionally, after association with an AP 402, a STA 404 also may periodically scan its surroundings to find a more suitable AP 402 with which to associate. For example, a STA 404 that is moving relative to its associated AP 402 may perform a “roaming” scan to find another AP 402 having more desirable network characteristics such as a greater received signal strength indicator (RSSI) or a reduced traffic load.

In some examples, STAs 404 may form networks without APs 402 or other equipment other than the STAs 404 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 400. In such examples, while the STAs 404 may be capable of communicating with each other through the AP 402 using communication links 406, STAs 404 also can communicate directly with each other via direct wireless communication links 410. Additionally, two STAs 404 may communicate via a direct wireless communication link 410 regardless of whether both STAs 404 are associated with and served by the same AP 402. In such an ad hoc system, one or more of the STAs 404 may assume the role filled by the AP 402 in a BSS. Such a STA 404 may be referred to as a group owner (GO) and may coordinate transmissions within the ad hoc network. Examples of direct wireless communication links 410 include Wi-Fi Direct connections, connections established by using a Wi-Fi Tunneled Direct Link Setup (TDLS) link, and other P2P group connections.

In some networks, the AP 402 or the STAs 404, or both, may support applications associated with high throughput or low-latency requirements, or may provide lossless audio to one or more other devices. For example, the AP 402 or the STAs 404 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 402 or the STAs 404 may support an extended personal audio network enabling communication with the two or more peripheral devices. Additionally, the AP 402 and STAs 404 may support additional ULL applications such as cloud-based applications (such as VR cloud gaming) that have ULL and high throughput requirements.

As indicated above, in some implementations, the AP 402 and the STAs 404 may function and communicate (via the respective communication links 406) according to one or more of the IEEE 802.11 family of wireless communication protocol standards. These standards define the WLAN radio and baseband protocols for the physical (PHY) and MAC layers. The AP 402 and STAs 404 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 402 and STAs 404 in the wireless communication network 400 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 402 and STAs 404 described herein also may communicate in other frequency bands that may support licensed or unlicensed communications. For example, the APs 402 or STAs 404, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHZ-52.6 GHz), FR3 (7.125 GHZ-24.25 GHz), FR4a or FR4-1 (52.6 GHZ-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

As indicated above, FIG. 4 is provided as an example. Other examples may differ from what is described with regard to FIG. 4.

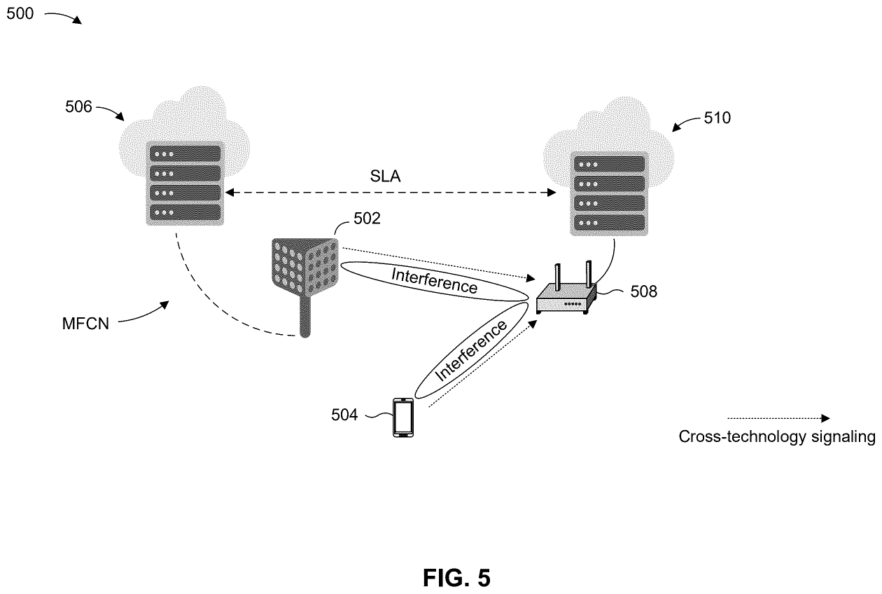

FIG. 5 is a diagram illustrating an example 500 of cross-technology sharing, in accordance with the present disclosure.

A mobile service and Wi-Fi may use spectrum in the same geographical area. In some scenarios, different technologies, such as high power macro cellular (e.g., 5G/6G) and Wi-Fi (e.g., IEEE 802.11bc), may share a spectrum (e.g., 3.5 GHz, 6 GHz) in a hybrid sharing framework. The hybrid sharing framework may be useful to enable spectrum sharing over the same geographical area when benefits are achieved for both a mobile/fixed cellular network (MFCN), or 5G, and an unlicensed Wi-Fi deployment. The hybrid sharing framework may relate to spectrum sharing between a standard power outdoor network node (e.g., an MFCN gNB) and an indoor Wi-Fi deployment (e.g., that uses a low power indoor (LPI) Wi-Fi AP). In some examples, the hybrid sharing framework may enable the reuse of existing 3.5 GHz site locations with a matching coverage area. The hybrid sharing framework may enable flexible and simple spectrum sharing that can adapt to dynamic traffic demands for each technology.

Example 500 shows communications between cellular entities (e.g., MFCN gNB 502, MFCN UE 504, and MFCN entity 506) and non-cellular entities (e.g., Wi-Fi AP 508 and authorization server 510), as well as the interference that may affect the communications. Interference degrades communications, which decreases throughput, wastes signaling resources, and increases latency. Accordingly, cross-technology sharing may provide interference management to address such interference.

In some examples, the Wi-Fi AP 508 may connect to the authorization server 510 (e.g., a spectrum sharing authorization server, such as an IEEE 802.11bc authorization server that can be leveraged to enhance sharing solution flexibility). In some examples, the MFCN (e.g., via the MFCN entity 506) may connect to the authorization server to set up a service level agreement (SLA), which may be for channel sharing operation. Otherwise, a default SLA may be assumed if the MFCN does not connect to the authorization server.

According to various aspects described herein, the cellular entities (e.g., gNB 502 and UE 504) may utilize a Wi-Fi waveform for cross-technology signaling. For example, the cellular entities may use Wi-Fi (e.g., IEEE 802.11bc) broadcast signals for cross-technology signaling. As shown in FIG. 5, the gNB 502 (e.g., the MFCN) may transmit a Wi-Fi waveform, and the Wi-Fi AP 508 may detect the Wi-Fi waveform. Uplink broadcast signals (e.g., IEEE 802.11bc uplink broadcast signals) may be useful to establish a jamming graph between cellular and Wi-Fi technologies. For example, the Wi-Fi AP 508 may detect interference in connection with generating the jamming graph. In some examples, the authorization server may control, or otherwise influence, a channel configuration (e.g., including bandwidth, primary channel number, and/or allowed maximum transmission power, among other examples) for the Wi-Fi AP 508 based on the SLA.

While most UEs (e.g., UE 504) are equipped with a WLAN or Wi-Fi modem that can generate a WLAN or Wi-Fi waveform used in cross-technology signaling, a network node (e.g., gNB 502) and some UEs may not be equipped with a WLAN or Wi-Fi modem. Moreover, adding a WLAN or Wi-Fi modem to a network node may complicate operations of the network node. Accordingly, such devices may be unable to transmit cross-technology signaling, which may lead to increases in cross-technology collisions and inefficient utilization of the spectrum by multiple technologies.

Various aspects relate generally to cross-technology signaling between a first RAT (e.g., a cellular RAT) and a second RAT (e.g., a WLAN RAT). Some aspects more specifically relate to transmitting a signal of the second RAT using a waveform that is generated based at least in part on the first RAT and the second RAT. For example, the waveform may be generated based at least in part on signal characteristics used by the first RAT or the second RAT (e.g., baseband sampling rate or carrier frequency). In some aspects, the waveform may duplicate information over multiple frequency ranges corresponding to channels of the second RAT that overlap with a transmission bandwidth of the first RAT.

Particular aspects of the subject matter described in this disclosure can be implemented to realize one or more of the following potential advantages. In some examples, by using cross-technology signaling, the described techniques can be used to facilitate interference management in spectrum sharing scenarios, thereby minimizing cross-technology collisions and improving utilization of the spectrum by multiple technologies. In some examples, by using a waveform that is generated based at least in part on the first RAT and the second RAT, the described techniques compensate mismatched signal characteristics between the first RAT and the second RAT to enable the signal of the second RAT to be transmitted using equipment (e.g., a modem or a transceiver) for the first RAT. In some examples, by duplicating information of the waveform over multiple frequency ranges corresponding to channels of the second RAT, the described techniques resolve differences between a transmission bandwidth of the first RAT and channel bandwidths of the second RAT, thereby improving a performance of the cross-technology signaling (e.g., in scenarios in which a primary channel of the second RAT is unknown to a transmitting device).

As indicated above, FIG. 5 is provided as an example. Other examples may differ from what is described with regard to FIG. 5.

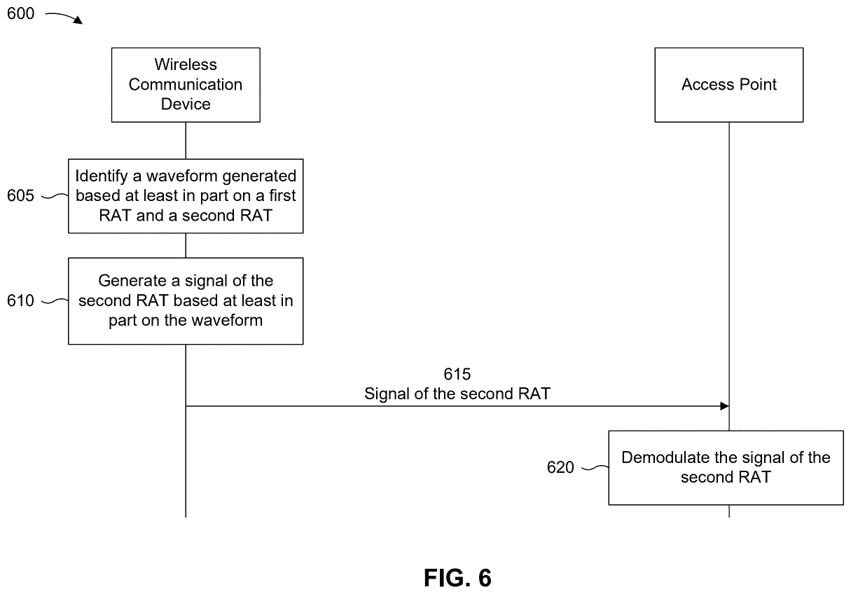

FIG. 6 is a diagram illustrating an example 600 of cross-technology signaling, in accordance with the present disclosure.

As shown in example 600, a wireless communication device and an access point (e.g., access point 160) may communicate in a wireless communication network (e.g., wireless communication network 100 and/or wireless communication network 400). The wireless communication device may perform wireless communication using a first RAT, and the access point may perform wireless communication using a second RAT. For example, the first RAT may be a cellular technology (e.g., 5G or 6G), and the second RAT may be a WLAN technology (e.g., Wi-Fi). The wireless communication device may be a network node (e.g., network node 110, CU 310, DU 330, and/or RU 340) or a UE (e.g., UE 120). The wireless communication device may support the first RAT, but may lack support for the second RAT. For example, the wireless communication device may have a modem that uses the first RAT (e.g., a cellular modem or a 5G or 6G modem), but may lack a modem that uses the second RAT (e.g., a WLAN modem or a Wi-Fi modem). The access point may be a WLAN access point, such as a Wi-Fi access point (e.g., an LPI Wi-Fi access point). The access point may support the second RAT, but may lack support for the first RAT. In some aspects, the wireless communication device may be deployed outdoors, and the access point may be deployed indoors.

In some aspects, a portion of licensed spectrum that the wireless communication device uses for wireless communication may overlap with a portion of unlicensed spectrum that the access point uses for wireless communication. Accordingly, the wireless communication device and the access point may use spectrum sharing in accordance with a hybrid sharing framework, as described herein. For example, the spectrum sharing may be in accordance with an SLA. In some aspects, cross-technology signaling from the wireless communication device to the access point may use a waveform of the second RAT (e.g., a WLAN or Wi-Fi waveform).

Because the wireless communication device may lack support for the second RAT, the wireless communication device may be unable to generate a waveform of the second RAT (e.g., in accordance with a baseband sampling rate, a carrier frequency, or the like, used by the second RAT). Accordingly, the wireless communication device may store one or more generated waveforms (e.g., pre-generated WLAN or Wi-Fi waveform(s)). For example, the generated waveform(s) may be stored in one or more sample files. In some aspects, a generated waveform may be a baseband waveform. In some aspects, a generated waveform may relate to a broadcast signal (e.g., a WLAN or Wi-Fi broadcast signal, such as an IEEE 802.11bc broadcast signal). In some aspects, a generated waveform may indicate spectrum sharing information and/or may be suitable for use in connection with interference management.

As shown by reference number 605, the wireless communication device may identify one or more waveforms (e.g., of the generated waveform(s) stored by the wireless communication device) that are to be used for cross-technology signaling. For example, the wireless communication device may retrieve a stored waveform. The waveform may have been generated (e.g., pre-generated) based at least in part on the first RAT and the second RAT. For example, the waveform may have been generated based at least in part on one or more signal characteristics used by the first RAT or the second RAT. As an example, the waveform may have been generated to compensate for one or more signal characteristics that differ between the first RAT and the second RAT. The signal characteristics may include baseband sampling rate and/or carrier frequency, among other examples. Accordingly, the waveform may account for a mismatch between the first RAT and the second RAT with respect to baseband sampling rate and/or carrier frequency, among other examples.

In some aspects, the waveform may duplicate information (e.g., duplicate the waveform) over multiple frequency ranges corresponding to channels of the second RAT (e.g., WLAN or Wi-Fi channels) that overlap with a transmission bandwidth of the first RAT (e.g., a cellular, 5G, or 6G transmission bandwidth). For example, the waveform may account for all primary Wi-Fi channels (e.g., candidate primary Wi-Fi channels) that overlap with a 5G transmission bandwidth (e.g., because the wireless communication device may be unaware of a location of the primary Wi-Fi channel). In some aspects, the information may have a non-high-throughput (non-HT) physical layer protocol data unit (PPDU) format. For example, the waveform may use a duplicated non-HT PPDU format occupying all, or a portion of, Wi-Fi channels (e.g., 20 MHz Wi-Fi channels) that overlap with the 5G bandwidth.

As shown by reference number 610, the wireless communication device may generate a signal of the second RAT based at least in part on (e.g., using) the waveform. For example, the waveform may be constructed such that when modulation is performed with the waveform using equipment for the first RAT (e.g., a cellular, 5G, or 6G modem) in accordance with signal characteristics for the first RAT, a signal in accordance with signal characteristics of the second RAT is produced. As an example, the signal of the second RAT may be a signal that can be demodulated in accordance with the second RAT (e.g., using a WLAN or Wi-Fi modem).

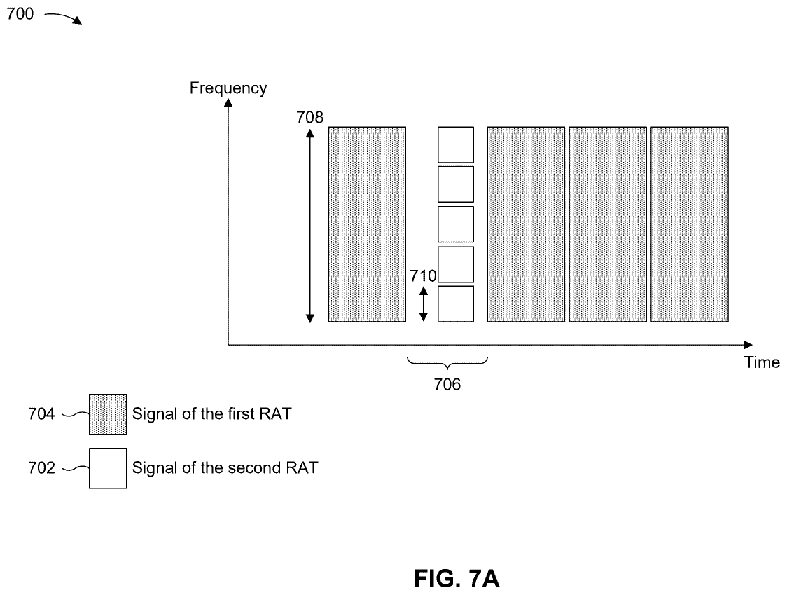

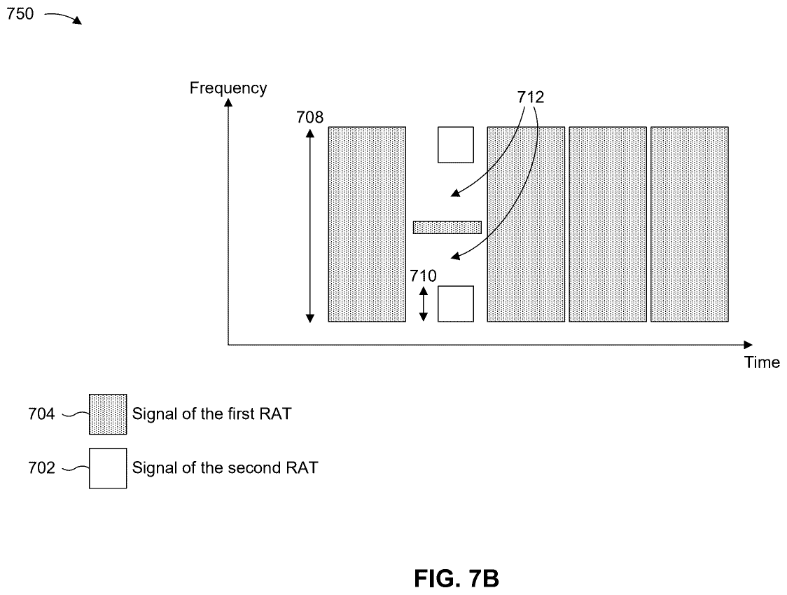

As shown by reference number 615, the wireless communication device may transmit, and the access point may receive, the signal of the second RAT (e.g., a WLAN or Wi-Fi signal) that is based at least in part on the waveform (e.g., the wireless communication device may transmit cross-technology signaling). For example, the wireless communication device may transmit the signal of the second RAT using a transceiver of the first RAT (e.g., a cellular transceiver, which may include a cellular, 5G, or 6G modem). Similarly, the access point may receive the signal of the second RAT using a transceiver of the second RAT (e.g., a WLAN transceiver, which may include a WLAN or Wi-Fi modem). In some aspects, the wireless communication device may transmit the signal of the second RAT using time division multiplexing (TDM) or frequency division multiplexing (FDM) with a signal of the first RAT, as described further in connection with FIGS. 7A-7B. As shown by reference number 620, the access point may demodulate the signal of the second RAT using a protocol for the second RAT (e.g., a WLAN or Wi-Fi protocol).

By enabling cross-technology signaling for wireless communication devices that lack native support for transmitting a cross-technology signal, techniques described herein facilitate interference management in spectrum sharing scenarios, thereby minimizing cross-technology collisions and improving utilization of the spectrum by multiple technologies.

As indicated above, FIG. 6 is provided as an example. Other examples may differ from what is described with regard to FIG. 6.

FIG. 7A is a diagram illustrating an example 700 of cross-technology signaling, in accordance with the present disclosure. Example 700 relates to the transmission of the signal of the second RAT, described in connection with reference number 615 of FIG. 6. For example, example 700 relates to time division multiplexing of the signal of the second RAT 702 with the signal of the first RAT 704. As shown, to transmit the signal of the second RAT 702, the wireless communication device may mute a transmission of the signal of the first RAT 704 for a time duration 706, and the wireless communication device may transmit the signal of the second RAT 702 during the time duration 706 (e.g., a waveform of the first RAT, such as a 5G waveform, may be muted for a sufficient duration to allow the waveform of the second RAT, such as a Wi-Fi waveform, to be transmitted instead of the waveform of the first RAT). In this way, the signal of the first RAT 704 and the signal of the second RAT 702 are time division multiplexed. As further shown, the signal of the second RAT may be transmitted over a transmission bandwidth of the first RAT 708 (e.g., a 5G bandwidth), and may be duplicated according to a channel bandwidth of the second RAT 710 (e.g., a Wi-Fi channel bandwidth or a Wi-Fi primary channel bandwidth).

As indicated above, FIG. 7A is provided as an example. Other examples may differ from what is described with regard to FIG. 7A.

FIG. 7B is a diagram illustrating an example 750 of cross-technology signaling, in accordance with the present disclosure.

Example 750 relates to the transmission of the signal of the second RAT, described in connection with reference number 615 of FIG. 6. For example, example 750 relates to frequency division multiplexing of the signal of the second RAT 702 with the signal of the first RAT 704. As shown, to transmit the signal of the second RAT 702, the wireless communication device may transmit the signal of the second RAT 702 and the signal of the first RAT 704 using frequency division multiplexing (e.g., a Wi-Fi waveform transmission may be frequency division multiplexed with a 5G waveform). Moreover, to transmit the signal of the second RAT 702 and the signal of the first RAT 704, the wireless communication device may transmit the signal of the second RAT 702 and the signal of the first RAT 704 using guard bands 712 between the signal of the second RAT 702 and the signal of the first RAT 704 (e.g., guard bands may be added between the 5G signal and the Wi-Fi signal, because the 5G signal and the Wi-Fi signal may have different symbol durations preventing the signals from being orthogonalized to each other). In some aspects, the signal of the first RAT 704 may be for data or control. For example, the signal of the first RAT 704 may be a synchronization signal block (SSB). As further shown, the signal of the second RAT 702 may be duplicated over multiple frequency ranges corresponding to the channel bandwidth of the second RAT 710 within the transmission bandwidth of the first RAT 708.

As indicated above, FIG. 7B is provided as an example. Other examples may differ from what is described with regard to FIG. 7B.

FIG. 8 is a diagram illustrating an example process 800 performed, for example, at a wireless communication device or an apparatus of a wireless communication device, in accordance with the present disclosure. Example process 800 is an example where the apparatus or the wireless communication device (e.g., network node 110 or UE 120) performs operations associated with cross-technology signaling.

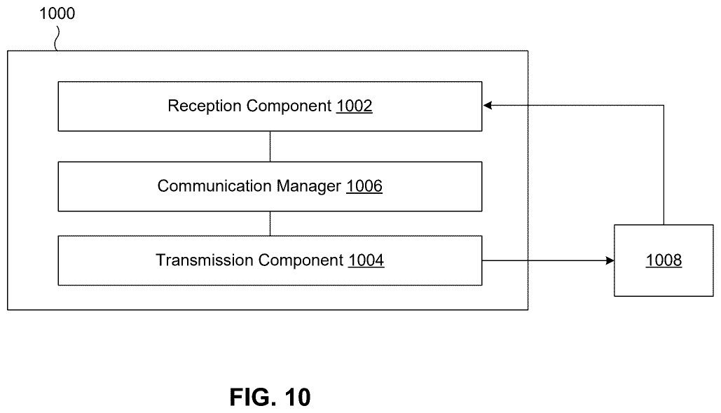

As shown in FIG. 8, in some aspects, process 800 may include identifying a waveform, the waveform generated based at least in part on a RAT and a second RAT (block 810). For example, the wireless communication device (e.g., using communication manager 1006, depicted in FIG. 10) may identify a waveform, the waveform generated based at least in part on a first RAT and a second RAT, as described above.

As further shown in FIG. 8, in some aspects, process 800 may include transmitting a signal of the second RAT based at least in part on the waveform (block 820). For example, the wireless communication device (e.g., using transmission component 1004 and/or communication manager 1006, depicted in FIG. 10) may transmit a signal of the second RAT based at least in part on the waveform, as described above.

Process 800 may include additional aspects, such as any single aspect or any combination of aspects described below and/or in connection with one or more other processes described elsewhere herein.

In a first aspect, the first RAT is a cellular technology, and the second RAT is a WLAN technology.

In a second aspect, alone or in combination with the first aspect, transmitting the signal of the second RAT includes transmitting the signal of the second RAT using a transceiver for the first RAT.

In a third aspect, alone or in combination with one or more of the first and second aspects, the waveform is generated based at least in part on one or more signal characteristics used by the first RAT or the second RAT.

In a fourth aspect, alone or in combination with one or more of the first through third aspects, the one or more signal characteristics include at least one of a baseband sampling rate, or a carrier frequency.

In a fifth aspect, alone or in combination with one or more of the first through fourth aspects, the waveform duplicates information over multiple frequency ranges corresponding to channels of the second RAT that overlap with a transmission bandwidth of the first RAT.

In a sixth aspect, alone or in combination with one or more of the first through fifth aspects, the information has a non-HT PPDU format.

In a seventh aspect, alone or in combination with one or more of the first through sixth aspects, transmitting the signal of the second RAT includes muting a transmission of a signal of the first RAT for a time duration, and transmitting the signal of the second RAT during the time duration.

In an eighth aspect, alone or in combination with one or more of the first through seventh aspects, transmitting the signal of the second RAT includes transmitting the signal of the second RAT and a signal of the first RAT using frequency division multiplexing.

In a ninth aspect, alone or in combination with one or more of the first through eighth aspects, the signal of the first RAT is an SSB.

In a tenth aspect, alone or in combination with one or more of the first through ninth aspects, transmitting the signal of the second RAT and the signal of the first RAT includes transmitting the signal of the second RAT and the signal of the first RAT using guard bands between the signal of the second RAT and the signal of the first RAT.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at an access point or an apparatus of an access point, in accordance with the present disclosure. Example process 900 is an example where the apparatus or the access point (e.g., access point 160) performs operations associated with cross-technology signaling.

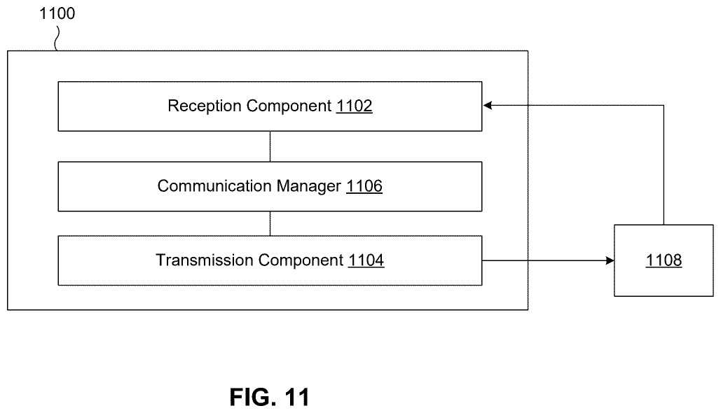

As shown in FIG. 9, in some aspects, process 900 may include receiving a signal of a second RAT that is based at least in part on a waveform, the waveform generated based at least in part on a first RAT and the second RAT (block 910). For example, the access point (e.g., using reception component 1102 and/or communication manager 1106, depicted in FIG. 11) may receive a signal of a second RAT that is based at least in part on a waveform, the waveform generated based at least in part on a first RAT and the second RAT, as described above.

As further shown in FIG. 9, in some aspects, process 900 may include demodulating the signal of the second RAT in accordance with a protocol for the second RAT (block 920). For example, the access point (e.g., using communication manager 1106, depicted in FIG. 11) may demodulate the signal of the second RAT in accordance with a protocol for the second RAT, as described above.

Process 900 may include additional aspects, such as any single aspect or any combination of aspects described below and/or in connection with one or more other processes described elsewhere herein.

In a first aspect, the first RAT is a cellular technology, and the second RAT is a WLAN technology.

In a second aspect, alone or in combination with the first aspect, receiving the signal of the second RAT includes receiving the signal of the second RAT using a transceiver for the second RAT.

In a third aspect, alone or in combination with one or more of the first and second aspects, the waveform is generated based at least in part on one or more signal characteristics used by the first RAT or the second RAT.

In a fourth aspect, alone or in combination with one or more of the first through third aspects, the one or more signal characteristics include at least one of a baseband sampling rate, or a carrier frequency.

In a fifth aspect, alone or in combination with one or more of the first through fourth aspects, the waveform duplicates information over multiple frequency ranges corresponding to channels of the second RAT that overlap with a transmission bandwidth of the first RAT.

In a sixth aspect, alone or in combination with one or more of the first through fifth aspects, the information has a non-HT PPDU format.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a wireless communication device, or a wireless communication device may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 or the communication manager 150 described in connection with FIG. 1. As shown, the apparatus 1000 may communicate with another apparatus 1008, such as a UE, a network node (such as a CU, a DU, an RU, or a base station), or an access point, using the reception component 1002 and the transmission component 1004.

In some aspects, the apparatus 1000 may be configured to perform one or more operations described herein in connection with FIGS. 6 and 7A-7B. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the wireless communication device described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the wireless communication device described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the wireless communication device described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The communication manager 1006 may identify a waveform that is generated based at least in part on a first RAT and a second RAT. The transmission component 1004 may transmit a signal of the second RAT based at least in part on the waveform.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a access point, or a access point may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 170 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6 and 7A-7B. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the access point described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the access point described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the access point described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a signal of a second RAT that is based at least in part on a waveform that is generated based at least in part on a first RAT and the second RAT. The communication manager 1106 may demodulate the signal of the second RAT in accordance with a protocol for the second RAT.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a wireless communication device, comprising: identifying a waveform, the waveform generated based at least in part on a first radio access technology (RAT) and a second RAT; and transmitting a signal of the second RAT based at least in part on the waveform.

Aspect 2: The method of Aspect 1, wherein the first RAT is a cellular technology, and the second RAT is a wireless local area network technology.

Aspect 3: The method of Aspect 1, wherein transmitting the signal of the second RAT comprises: transmitting the signal of the second RAT using a transceiver for the first RAT.

Aspect 4: The method of any of Aspects 1-3, wherein the waveform is generated based at least in part on one or more signal characteristics used by the first RAT or the second RAT.

Aspect 5: The method of Aspect 4, wherein the one or more signal characteristics include at least one of: a baseband sampling rate, or a carrier frequency.

Aspect 6: The method of any of Aspects 1-5, wherein the waveform duplicates information over multiple frequency ranges corresponding to channels of the second RAT that overlap with a transmission bandwidth of the first RAT.

Aspect 7: The method of Aspect 6, wherein the information has a non-high-throughput physical layer protocol data unit (PPDU) format.

Aspect 8: The method of any of Aspects 1-7, wherein transmitting the signal of the second RAT comprises: muting a transmission of a signal of the first RAT for a time duration; and transmitting the signal of the second RAT during the time duration.

Aspect 9: The method of any of Aspects 1-7, wherein transmitting the signal of the second RAT comprises: transmitting the signal of the second RAT and a signal of the first RAT using frequency division multiplexing.

Aspect 10: The method of Aspect 9, wherein the signal of the first RAT is a synchronization signal block.

Aspect 11: The method of any of Aspects 9-10, wherein transmitting the signal of the second RAT and the signal of the first RAT comprises: transmitting the signal of the second RAT and the signal of the first RAT using guard bands between the signal of the second RAT and the signal of the first RAT.

Aspect 12: A method of wireless communication performed by an access point, comprising: receiving a signal of a second radio access technology (RAT) that is based at least in part on a waveform, the waveform generated based at least in part on a first RAT and the second RAT; and demodulating the signal of the second RAT in accordance with a protocol for the second RAT.

Aspect 13: The method of Aspect 12, wherein the first RAT is a cellular technology, and the second RAT is a wireless local area network technology.

Aspect 14: The method of Aspect 12, wherein receiving the signal of the second RAT comprises: receiving the signal of the second RAT using a transceiver for the second RAT.

Aspect 15: The method of any of Aspects 12-14, wherein the waveform is generated based at least in part on one or more signal characteristics used by the first RAT or the second RAT.

Aspect 16: The method of Aspect 15, wherein the one or more signal characteristics include at least one of: a baseband sampling rate, or a carrier frequency.

Aspect 17: The method of any of Aspects 12-16, wherein the waveform duplicates information over multiple frequency ranges corresponding to channels of the second RAT that overlap with a transmission bandwidth of the first RAT.

Aspect 18: The method of Aspect 17, wherein the information has a non-high-throughput physical layer protocol data unit (PPDU) format.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 20: An apparatus for wireless communication at a device, the apparatus comprising one or more memories and one or more processors coupled to the one or more memories, the one or more processors configured to cause the device to perform the method of one or more of Aspects 1-18.

Aspect 21: An apparatus for wireless communication, the apparatus comprising at least one means for performing the method of one or more of Aspects 1-18.

Aspect 22: A non-transitory computer-readable medium storing code for wireless communication, the code comprising instructions executable by one or more processors to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

Aspect 24: A device for wireless communication, the device comprising a processing system that includes one or more processors and one or more memories coupled with the one or more processors, the processing system configured to cause the device to perform the method of one or more of Aspects 1-18.

Aspect 25: An apparatus for wireless communication at a device, the apparatus comprising one or more memories and one or more processors coupled to the one or more memories, the one or more processors individually or collectively configured to cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for case of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication at a wireless communication device, comprising:
one or more memories; and
one or more processors, coupled to the one or more memories, configured to cause the wireless communication device to:
identify a waveform, the waveform generated based at least in part on a first radio access technology (RAT) and a second RAT; and
transmit a signal of the second RAT based at least in part on the waveform.

2. The apparatus of claim 1, wherein the first RAT is a cellular technology, and the second RAT is a wireless local area network technology.

3. The apparatus of claim 1, wherein the one or more processors, to cause the wireless communication device to transmit the signal of the second RAT, are configured to cause the wireless communication device to:
transmit the signal of the second RAT using a transceiver for the first RAT.

4. The apparatus of claim 1, wherein the waveform is generated based at least in part on one or more signal characteristics used by the first RAT or the second RAT.

5. The apparatus of claim 4, wherein the one or more signal characteristics include at least one of:
a baseband sampling rate, or
a carrier frequency.

6. The apparatus of claim 1, wherein the waveform duplicates information over multiple frequency ranges corresponding to channels of the second RAT that overlap with a transmission bandwidth of the first RAT.

7. The apparatus of claim 6, wherein the information has a non-high-throughput physical layer protocol data unit (PPDU) format.

8. The apparatus of claim 1, wherein the one or more processors, to cause the wireless communication device to transmit the signal of the second RAT, are configured to cause the wireless communication device to:
mute a transmission of a signal of the first RAT for a time duration; and
transmit the signal of the second RAT during the time duration.

9. The apparatus of claim 1, wherein the one or more processors, to cause the wireless communication device to transmit the signal of the second RAT, are configured to cause the wireless communication device to:
transmit the signal of the second RAT and a signal of the first RAT using frequency division multiplexing.

10. The apparatus of claim 9, wherein the signal of the first RAT is a synchronization signal block.

11. The apparatus of claim 9, wherein the one or more processors, to cause the wireless communication device to transmit the signal of the second RAT and the signal of the first RAT, are configured to cause the wireless communication device to:
transmit the signal of the second RAT and the signal of the first RAT using guard bands between the signal of the second RAT and the signal of the first RAT.

12. A method of wireless communication performed by a wireless communication device, comprising:
identifying a waveform, the waveform generated based at least in part on a first radio access technology (RAT) and a second RAT; and
transmitting a signal of the second RAT based at least in part on the waveform.

13. The method of claim 12, wherein the first RAT is a cellular technology, and the second RAT is a wireless local area network technology.

14. The method of claim 12, wherein transmitting the signal of the second RAT comprises:
transmitting the signal of the second RAT using a transceiver for the first RAT.

15. The method of claim 12, wherein the waveform is generated based at least in part on one or more signal characteristics used by the first RAT or the second RAT.

16. The method of claim 15, wherein the one or more signal characteristics include at least one of:
a baseband sampling rate, or
a carrier frequency.

17. The method of claim 12, wherein the waveform duplicates information over multiple frequency ranges corresponding to channels of the second RAT that overlap with a transmission bandwidth of the first RAT.

18. The method of claim 17, wherein the information has a non-high-throughput physical layer protocol data unit (PPDU) format.

19. The method of claim 12, wherein transmitting the signal of the second RAT comprises:
muting a transmission of a signal of the first RAT for a time duration; and
transmitting the signal of the second RAT during the time duration.

20. The method of claim 12, wherein transmitting the signal of the second RAT comprises:
transmitting the signal of the second RAT and a signal of the first RAT using frequency division multiplexing.

21. The method of claim 20, wherein the signal of the first RAT is a synchronization signal block.

22. The method of claim 20, wherein transmitting the signal of the second RAT and the signal of the first RAT comprises:
transmitting the signal of the second RAT and the signal of the first RAT using guard bands between the signal of the second RAT and the signal of the first RAT.

23. A non-transitory computer-readable medium storing a set of instructions for wireless communication, the set of instructions comprising:
one or more instructions that, when executed by one or more processors of a wireless communication device, cause the wireless communication device to:
identify a waveform, the waveform generated based at least in part on a first radio access technology (RAT) and a second RAT; and
transmit a signal of the second RAT based at least in part on the waveform.

24. The non-transitory computer-readable medium of claim 23, wherein the first RAT is a cellular technology, and the second RAT is a wireless local area network technology.

25. The non-transitory computer-readable medium of claim 23, wherein the one or more instructions, that cause the wireless communication device to transmit the signal of the second RAT, cause the wireless communication device to:
transmit the signal of the second RAT using a transceiver for the first RAT.

26. The non-transitory computer-readable medium of claim 23, wherein the waveform is generated based at least in part on one or more signal characteristics used by the first RAT or the second RAT.

27. The non-transitory computer-readable medium of claim 23, wherein the waveform duplicates information over multiple frequency ranges corresponding to channels of the second RAT that overlap with a transmission bandwidth of the first RAT.

28. The non-transitory computer-readable medium of claim 23, wherein the one or more instructions, that cause the wireless communication device to transmit the signal of the second RAT, cause the wireless communication device to:
mute a transmission of a signal of the first RAT for a time duration; and
transmit the signal of the second RAT during the time duration.

29. The non-transitory computer-readable medium of claim 23, wherein the one or more instructions, that cause the wireless communication device to transmit the signal of the second RAT, cause the wireless communication device to:
transmit the signal of the second RAT and a signal of the first RAT using frequency division multiplexing.

30. An apparatus for wireless communication, comprising:
means for identifying a waveform, the waveform generated based at least in part on a first radio access technology (RAT) and a second RAT; and
means for transmitting a signal of the second RAT based at least in part on the waveform.
